(19) United States
(12) Patent Application Publication
(10) Pub. No.: US 2012/0233149 A1
(43) Pub. Date: Sep. 13, 2012

(54) EFFICIENT PROCESSING OF BULK QUERIES TO DETERMINE THE AVAILABILITY OF RESOURCES

(75) Inventors: Ramana Yerneni, Cupertino, CA (US); Manu Sreenivasachar, Santa Clara, CA (US); Haiying Huang, Palo Alto, CA (US)

(73) Assignee: Yahoo! Inc., Sunnyvale, CA (US)

(21) Appl. No.: 13/043,020

(22) Filed: Mar. 8, 2011

(51) Int. Cl. G06F 17/30

(52) U.S. Cl. 707/720; 707/E17.017

(57) ABSTRACT

Systems and methods for automatically determining the availability of resources, such as Internet advertising opportunities, are described herein. The systems and methods efficiently process bulk queries that specify multiple target values for at least one attribute associated with the resources, such bulk queries being useful for determining the availability of a wide variety of different resource types.

### BACKGROUND OF THE INVENTION

1. Field of the Invention

The present invention generally relates to systems and methods for processing queries to determine the availability of one or more desired resources. The desired resources may include, but are not limited to, Internet advertising opportunities.

2. Background

The Internet has emerged as a powerful advertising tool. It is commonplace to see advertisements on many Web sites. For example, advertisements may be displayed on search Web sites and may be targeted to individuals based upon search terms submitted by the individuals. Other Web sites, such as news and sports Web sites, may provide space for display advertisements. Proprietors of these Web sites may sell advertising space to advertisers to offset the costs associated with operating the Web sites as well as to turn a profit.

To place an advertisement, an advertiser may enter into a contract with a publisher that operates an ad serving system to serve a number of advertisement impressions. An impression corresponds to the display of an advertisement to a user. For example, the advertiser may purchase 10,000 impressions for $100 and may specify a particular target audience, such as users that like sports.

When preparing to enter a contract, the advertiser (or an agent thereof) may interact with a system that allows the advertiser to specify the types of advertisement opportunities in which the advertiser is interested so as to determine the availability thereof. This may involve selecting one or more target attributes from among a set of attributes and then specifying a target value for each of the target attributes. The target attributes may include, for example, attributes associated with the viewers that will view an impression (e.g., gender, age group), attributes associated with the content of the Web page on which the impression will be delivered, attributes involving the location of the impression on the Web page, a time period during which the impression will be served, and the like. The target values specified by the advertiser for the target attributes can then be used as a query to search for available advertising opportunities having attributes/value combinations that match the target attributes/values.

In some instances, the advertiser may wish to obtain availability information for a large landscape of different advertising opportunity types. To accommodate this, the system may enable the advertiser to specify multiple target values for each of various target attributes (e.g., to specify multiple target age groups or multiple content topics). The multiple target values specified by the advertiser for the target attributes can be represented in a bulk query that is in fact the union of multiple constituent queries corresponding to different sub-combinations of the target attributes/values. In response to the execution of such a bulk query, it is desirable to return availability information for each of the constituent queries that make up the bulk query. However, obtaining accurate availability information for each constituent query that makes up the bulk query can be extremely time consuming and processor intensive.

### BRIEF SUMMARY OF THE INVENTION

Systems and methods for automatically determining the availability of resources, such as Internet advertising opportunities, are described herein. The systems and methods efficiently process bulk queries that specify multiple target values for at least one attribute associated with the resources, such bulk queries being useful for determining the availability of a wide variety of different resource types.

In particular, a method for automatically determining the availability of resources is described herein. In accordance with the method, a bulk query is received that specifies one or more attributes associated with the resources and one or more target values for each of the one or more attributes, wherein the bulk query specifies a plurality of target values for at least one of the one or more attributes. The bulk query is converted into a plurality of constituent queries, wherein each constituent query specifies only a single target value for at least one of the one or more attributes for which a plurality of target values was specified in the bulk query. A number of available resources is then estimated for each of the constituent queries. This is achieved by processing a first predefined number of supply samples obtained for each of the constituent queries, each of the supply samples obtained for a particular constituent query representing resources that satisfy the particular constituent query. The first predefined number of supply samples obtained for each of the constituent queries is less than a second predefined number of supply samples obtained and processed for estimating a number of available resources for a non-bulk query.

An alternative method for automatically determining the availability of resources is also described herein. In accordance with this method, a bulk query is received that specifies one or more attributes associated with the resources and one or more target values for each of the one or more attributes, wherein the bulk query specifies a plurality of target values for at least one of the one or more attributes. The bulk query is converted into a plurality of constituent queries, wherein each constituent query specifies only a single target value for at least one of the one or more attributes for which a plurality of target values was specified in the bulk query. A number of available resources is then estimated for each of the constituent queries by processing a first predefined number of supply samples obtained for the bulk query, the supply samples obtained for the bulk query representing resources that satisfy the bulk query. The first predefined number of supply samples obtained for the bulk query is greater than a second predefined number of supply samples obtained and processed for estimating a number of available resources for a non-bulk query.

A further alternative method for automatically determining the availability of resources is also described herein. In accordance with this method, a bulk query is received that specifies one or more attributes associated with the resources and one or more target values for each of the one or more attributes, wherein the bulk query specifies a plurality of target values for at least one of the one or more attributes. The bulk query is converted into a plurality of constituent queries, wherein each constituent query specifies only a single target value for at least one of the one or more attributes for which a plurality of target values was specified in the bulk query. If the number of constituent queries in the plurality of constituent queries exceeds a predefined threshold, then a number of available resources is estimated for each of the constituent queries by processing a first predefined number of supply samples obtained for the bulk query, the supply samples obtained for the bulk query representing resources that satisfy the bulk query. If the number of constituent queries in the plurality of constituent queries does not exceed the predefined threshold, then a number of available resources is estimated for each of the constituent queries by processing a second predefined number of supply samples obtained for each of the constituent queries, each of the supply samples obtained for a particular constituent query representing resources that satisfy the particular constituent query. The first predefined number is larger than the second predefined number.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram of an example display advertising system in which an embodiment may operate.

FIG. 2 illustrates supply samples that may be returned by a supply forecasting system in response to the submission of a query in accordance with an embodiment.

FIG. 3 illustrates a plurality of advertising campaigns that may exist at the time a query is being processed and advertising opportunity demand associated therewith in accordance with an embodiment.

FIG. 4 illustrates the allocation of a forecasted supply of advertising opportunities represented by supply samples to existing advertising campaigns in accordance with an embodiment.

FIG. 5 depicts an exemplary graphical user interface (GUI) that may be used by the advertiser to obtain availability information for certain types of advertising opportunities in accordance with an embodiment.

FIG. 6 depicts an example GUI for presenting an advertiser with results of a bulk query in accordance with an embodiment.

FIG. 7 illustrates supply samples that may be returned by a supply forecasting system in response to the submission of a hulk query in accordance with an embodiment.

FIG. 8 illustrates the allocation of a forecasted supply of advertising opportunities represented by supply samples obtained for a bulk query to existing advertising campaigns in accordance with an embodiment.

FIG. 9 illustrates the allocation of available advertising opportunities represented by supply samples obtained for a bulk query to different constituent queries associated with the bulk query in accordance with an embodiment.

FIG. 10 depicts a flowchart of a method for determining the availability of a resource in accordance with an embodiment in which constituent queries associated with a bulk query are separately processed at a minimum resolution level.

FIG. 11 depicts a flowchart of a method for estimating a number of available resources for each of a plurality of constituent queries associated with a bulk query by processing a predefined number of supply samples obtained for each of the constituent queries in accordance with an embodiment.

FIG. 12 depicts a flowchart of a method for determining the availability of a resource in accordance with an embodiment in which a bulk query is processed at a maximum resolution level.

FIG. 13 depicts a flowchart of a method for estimating a number of available resources for each of a plurality of constituent queries associated with a bulk query by processing a predefined number of supply samples obtained for the bulk query in accordance with an embodiment.

FIG. 14 depicts a flowchart of a method for determining the availability of a resource in accordance with an embodiment that either separately processes constituent queries associated with a bulk query at a minimum resolution level or processes the bulk query at a maximum resolution level.

FIG. 15 is a block diagram of a computer system that may be used to implement one or more aspects of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### A. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated, embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

### B. Example Display Advertising System

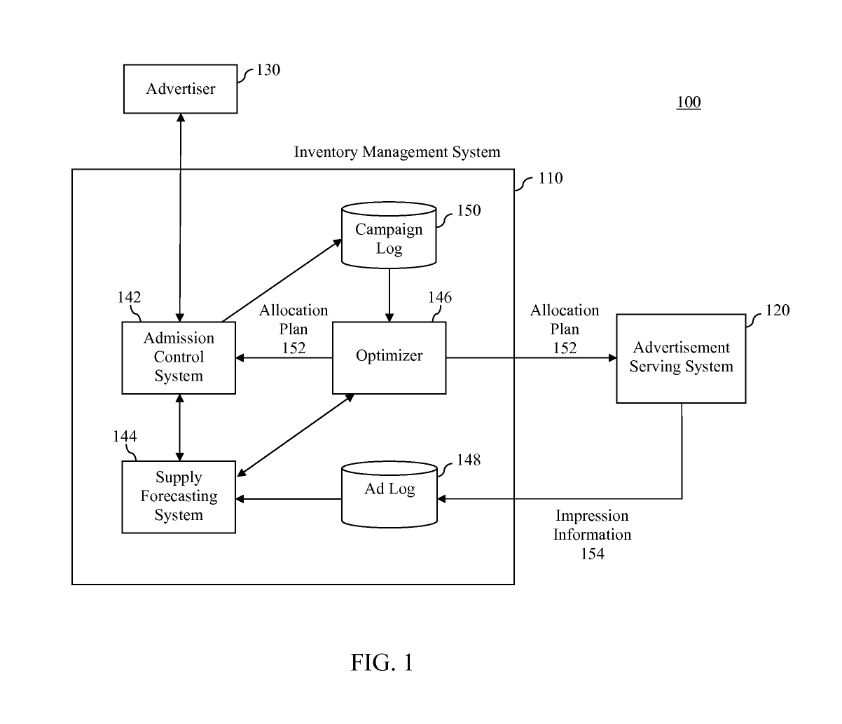

FIG. 1 is a block diagram of an example display advertising system 100 in which an embodiment of the present invention may operate. As shown in FIG. 1, display advertisement system 100 includes an inventory management system 110 and an advertisement serving system 120. Inventory management system 110 is an automated system that is designed to enable advertisers to purchase or reserve in advance advertising opportunities that will arise when users of the Internet visit Web pages. Such purchasing or reserving in advance is also referred to herein as “booking.” Advertisement serving system 120 is an automated system that is designed to serve display advertisements on behalf of such advertisers when such booked advertising opportunities arise.

In accordance with the system shown in FIG. 1, an advertiser, such as advertiser 130, interacts with inventory management system 110 to set up an advertising campaign, wherein part of setting up an advertising campaign includes booking certain advertising opportunities. Based on such booking activity, inventory management system 110 updates an allocation plan 152 that indicates which advertising opportunities have been booked by which campaigns and intermittently provides allocation plan 152 to advertisement serving system 120.

Advertisement serving system 120 utilizes the most recently-received version of allocation plan 152 to determine which display advertisements to serve when a Web page is delivered to a user that includes a particular advertising opportunity. In other words, advertisement serving system 120 determines which campaigns consume which advertising opportunities based on information provided in allocation plan 152. When a display advertisement is served, an impression is said to have occurred, and information about the impression is stored in an advertisement (“ad”) log 148 that comprises part of inventory management system 110. Such impression information 154 includes an identification of the advertising campaign to which the impression was allocated. Information stored in ad log 148 is then used by inventory management system 110 to update allocation plan 152 to account for the consumption of certain advertising opportunities by certain advertising campaigns.

Although reference is made herein to interactions between advertisers, such as advertiser 130, and inventory management system 110, it is to be understood that other entities, including but not limited to agents acting on behalf of advertisers, may also interact with inventory management system 110 to set up advertising campaigns, query and book advertising opportunities, and the like.

To enable advertisers to book certain targeted advertising opportunities for their advertising campaigns and to forecast and track the consumption of such booked advertising opportunities by various advertising campaigns, display advertising system 100 characterizes each impression that is served using a predefined set of attributes and associated values. For example, the predefined set of attributes may include but are not limited to: a content topic (e.g., sports, news, finance) of a Web page on which the impression is served, a position of the impression on such Web page, a gender of a viewer of the impression, an age category of a viewer of the impression, a geographical location of a viewer of the impression, and a behavior tag that signifies certain behaviors or preferences of a viewer of the impression.

Thus, for example, an impression denoted IMP1 may be represented by the following set of <attribute, value> pairs:
IMP1: Content Topic=Sports, Position=NREC, Gender=Male, Age Category=2, Location=CA, Behavior Tag=Politics, . . .
   In accordance with this representation, advertisement impression IMP1 is served on a Web page having a content topic of sports, is served in a northern rectangle (NREC) position on the Web page, is served to a male user in an age category represented by the number 2, wherein the male user is geographically located in California (CA) and has shown a prior interest in content related to politics.

Inventory management system 110 will now be further described. As shown in FIG. 1, in addition to ad log 148 which was discussed above, inventory management system 110 further includes an admission control system 142, a supply forecasting system 144, an optimizer 146 and a campaign log 150. Each of these components will now be described.

Admission control system 142 is configured to receive booking queries from advertisers, such as advertiser 130, that specify advertising opportunities in which the advertiser is interested. The queries specify target values for some or all of the attributes associated with the advertising opportunities they target. Thus, for example, with continued reference to the particular example <attribute, value> schema discussed above, an example query Q1 might be specified as follows:

Q1: Content Topic=Sports, Position=NREC, Location=CA

Here the target attributes are Content Topic, Position and Location, and each target attribute has a designated target value. In accordance with these target <attribute, value> pairs, query Q1 is seeking advertising opportunities in a northern rectangle position of Web pages having a content topic of sports and that will be served to a user located in California. Another example query Q2 might be specified as follows:

Q2: Content Topic=News, Position=EREC, Age Category=3

Here the target attributes are Content Topic, Position and Age Category, and each target attribute has a designated target value. In accordance with these target <attribute, value> pairs, query Q2 is seeking advertising opportunities in an eastern rectangle position of Web pages having a content topic of news and that will be served to a user within age category 3.

Admission control system 142 interacts with supply forecasting system 144 to obtain an estimate of how many advertising opportunities will be available in the future that match or otherwise qualify for a query. An impression matches or otherwise qualifies for a query when the values of its attributes satisfy the conditions specified by the query. Thus, for example, an advertising opportunity in the form of unconsumed impression IMP1 may be specified as follows:
IMP1: Content Topic Sports, Position NREC, Gender=Male, Age Category=2, Location=CA, Behavior Tag=Politics, . . .
   It can be seen from this example that impression IMP1 matches query Q1 as described above, but does not match query Q2.

Booking queries are intended to determine the availability of as-yet-unconsumed impressions at some point in the future. Thus, in certain embodiments, the queries include a duration attribute, the value of which specifies a time period over which the desired advertising opportunity will arise. Thus for example, a query may specify a target profile in accordance with

Profile: Content Topic=Sports, Position=NREC, Location=CA

as well as a target duration in accordance with
Duration=Mar. 15, 2011-Mar. 31, 2011.
   To process such a query, inventory management system 100 must be able to forecast the supply of advertising opportunities that will arise during the specified future time window. This function is performed by supply forecasting system 144.

In particular, supply forecasting system 144 utilizes historical information obtained from ad log 148 to model the future availability of various types of advertising opportunities. Optimizer 146 operates to obtain a forecasted supply of advertising opportunities from supply forecasting system 144 and allocates such forecasted supply among various existing advertising campaigns, information about which is stored in campaign log 150. In particular, optimizer 146 uses information about future supply obtained from supply forecasting system 144 and booked demand obtained from campaign log 150 to update allocation plan 152. As noted above, allocation plan 152 is delivered to advertisement serving system 120 and is used thereby to drive the allocation of certain types of impressions to certain advertising campaigns.

As shown in FIG. 1, allocation plan 152 is also intermittently delivered to admission control system 142. Admission control system 142 uses the most recently-received allocation plan 152 to make decisions about booking new advertising campaigns. For example, admission control system 142 may use allocation plan 152 along with forecasted supply information from supply forecasting system 144 to determine whether a certain number of advertising opportunities are available to be booked by a new advertising campaign. If admission control system 142 books a new advertising campaign, then admission control system 142 will send information concerning the booking to campaign log 150 so that such information may be subsequently considered by optimizer 146 when generating an updated version of allocation plan 152.

### C. Example Query Processing Technique

An example technique by which admission control system 142 of display advertising system 100 may process a booking query will now be described. The query processing described in this section does not involve bulk queries. Rather, the handling of such bulk queries will be described in subsequent sections.

Generally speaking, when admission control system 142 receives a booking query, it first interacts with supply forecasting system 144 to obtain a relevant forecasted supply of advertising opportunities that match the query. Admission control system 142 then uses allocation plan 152 obtained from optimizer 146 to determine how much of this forecasted supply is already allocated to existing advertising campaigns and reduces the forecasted supply accordingly to identify an available supply. Admission control system 142 then returns the available supply of advertising opportunities to the submitter of the query.

The forecasted supply of advertising opportunities that is provided by supply forecasting system 144 in response to the processing of a query is represented by a number of advertising opportunity samples, also referred to herein as supply samples. The technique by which supply forecasting system 144 obtains such supply samples is termed “representative sampling,” In one embodiment, each supply sample has a weight associated with it that reflects the amount of advertising opportunities represented by that sample. In further accordance with such an embodiment, the total forecasted supply for a query may be the sum of the weights of the supply samples.

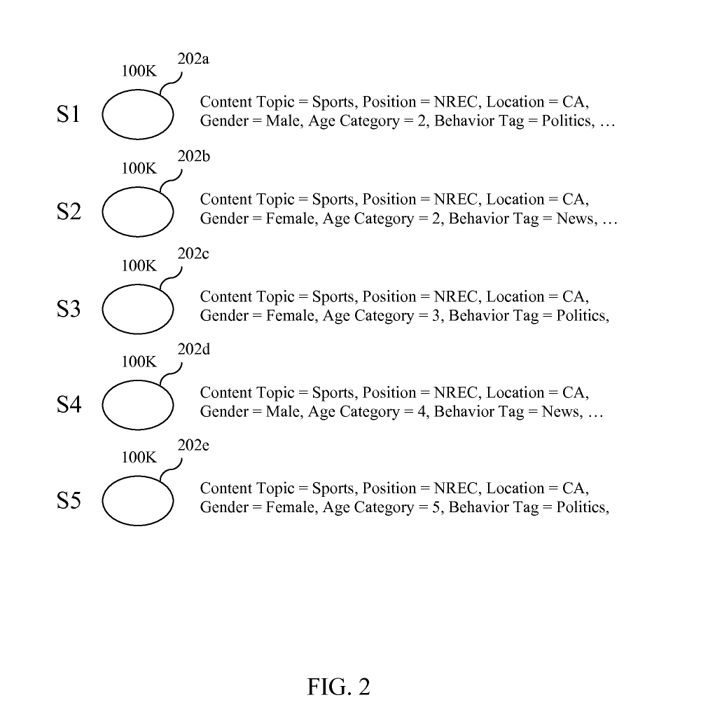

For example, FIG. 2 illustrates five supply samples, S1-S5 (corresponding to reference numerals 202a-202e), that may be returned by supply forecasting system 144 in response to the submission of a given query Q, wherein
Q: Content Topic=Sports, Position=NREC, Location=CA, Duration=Mar. 15, 2011-Mar. 31, 2011
   In accordance with this example, responsive to receiving query Q, supply forecasting system 144 determines a total amount of forecasted supply, which is 500,000 advertising opportunities. Supply forecasting system 144 then selects a subset of the forecasted supply, which in this example is five supply samples, to represent the total forecasted supply. The number of advertising opportunities represented by each supply sample S1-S5 is denoted by a weight associated with each sample. In this case, each supply sample S1-S5 represents 100,000 samples and thus, supply samples S1-S5 collectively represent all 500,000 forecasted advertising opportunities. It is to be understood that supply samples S1-S5 shown in FIG. 2 have timestamps in the duration range of query Q as discussed above (i.e., in the time range of Mar. 15, 2011-Mar. 31, 2011).

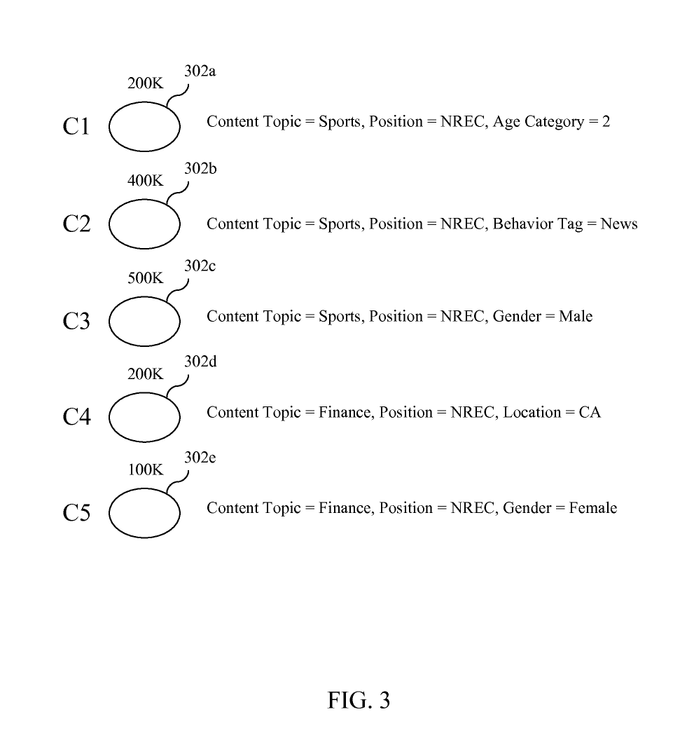

After obtaining the supply samples from supply forecasting system 144, admission control system 142 determines the existing demand for the advertising opportunities represented by such samples. Such existing demand is due to the allocation of the advertising opportunities to existing advertising campaigns and can be determined from allocation plan 152. For example, FIG. 3 illustrates five advertising campaigns, C1-C5 (corresponding to reference numerals 302a-302e), that may exist at the time the query Q is being processed and the demand associated with each. In accordance with the example of FIG. 3, campaign C1 will consume 200,000 advertising opportunities that have a profile of:

Content Topic=Sports, Position=NREC, Age Category=2.

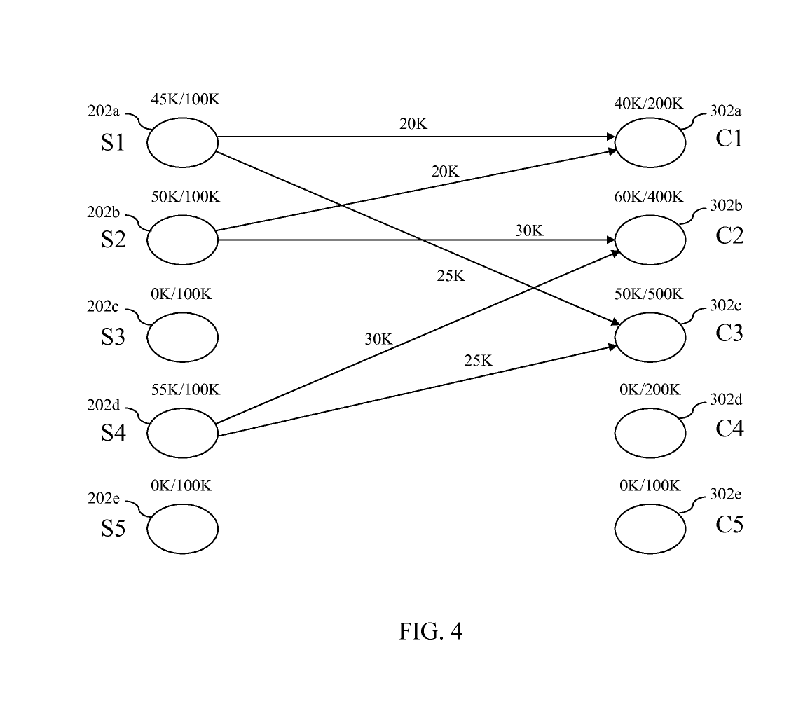

As further shown in FIG. 3, campaigns C2-C5 will consume varying amounts of other types of advertising opportunities. It is to be understood that for an advertising campaign to consume advertising opportunities, the advertising campaign must be active during the same time window in which the advertising opportunities arise. With reference to the example of FIG. 3, it may be assumed that each of advertising campaigns C1-C5 is active during the relevant time window of Mar. 15, 2011-Mar. 31, 2011. Using the supply samples provided by supply forecasting system 144 and the demand information obtained from allocation plan 152, admission control system 142 determines an allocation of the forecasted supply of advertising opportunities represented by the supply samples to each of the existing advertising campaigns. For example, FIG. 4 illustrates the allocation of the forecasted supply of advertising opportunities represented by supply samples S1-S5 as previously described in reference to FIG. 2 to existing advertising campaigns C1-C5 as previously described in reference to FIG. 3.

As shown in FIG. 4, advertising campaign C1 can consume advertising opportunities represented by supply samples S1 and S2 since the target attribute/values associated with advertising campaign C1 (i.e., Content Topic=Sports, Position=NREC, Age Category=2) match the attribute/values associated with supply samples S1 and S2. In further accordance with this example, based on information included, in allocation plan 152, admission control system 142 estimates that advertising campaign C1 will consume 20,000 of the advertising opportunities represented by supply sample S1 and 20,000 of the advertising opportunities represented by supply sample S2.

As further shown in FIG. 4, admission control system 142 also determines that advertising campaign C2 will consume 30,000 of the advertising opportunities represented by supply sample S2 and 30,000 of the advertising opportunities represented by supply sample S4 and that advertising campaign C3 will consume 25,000 of the advertising opportunities represented by supply sample S1 and 25,000 of the advertising opportunities represented by supply sample S4. Admission control system 142 further determines that advertising campaigns C4 and C5 will not consume any of the advertising opportunities represented by supply samples S1-S5 because these advertising campaigns have target attribute/values associated therewith that do not match any of the attribute/values associated with any of supply samples S1-S5.

After admission control system 142 has determined the allocation of the forecasted supply of advertising opportunities represented by the supply samples to each of the existing advertising campaigns, admission control system 142 then reduces the weights associated with the supply samples accordingly. Thus, in further accordance with the example shown in FIG. 4, since a total of 45,000 of the advertising samples represented by supply sample S1 have been allocated to existing advertising campaigns, the weight associated with supply sample S1 is reduced to 55,000. Using a like approach, the weight associated with supply sample S2 is reduced to 50,000 and the weight associated with supply sample S4 is reduced to 45,000. The weights associated with supply samples S3 and S5 are not reduced, since none of the advertising opportunities represented by those supply samples have been allocated to existing advertising campaigns.

Admission control system 142 then sums the adjusted weights associated with the supply samples to determine an available supply of advertising opportunities that will satisfy the query. For example, in further accordance with the example of FIG. 4, the reduced weights of 55,000 for supply sample S1, 50,000 for supply sample S2, and 45,000 for supply sample S4 are added to the 100,000 weight for supply sample S3 and the 100,000 weight for supply sample S5 to obtain a total available supply of 350,000 advertising opportunities that will satisfy the query Q.

### D. Example Fuzzy Processing Technique for Bulk Queries

In some instances, advertisers, such as advertiser 130, may wish to obtain availability information for a large landscape of different advertising opportunity types. To accommodate this, inventory management system 110 enables advertisers to specify multiple target values for each of various target attributes. The multiple target values specified for the target attributes can be represented in a bulk query that is in fact the union of multiple constituent queries corresponding to different sub-combinations of the target attributes/values.

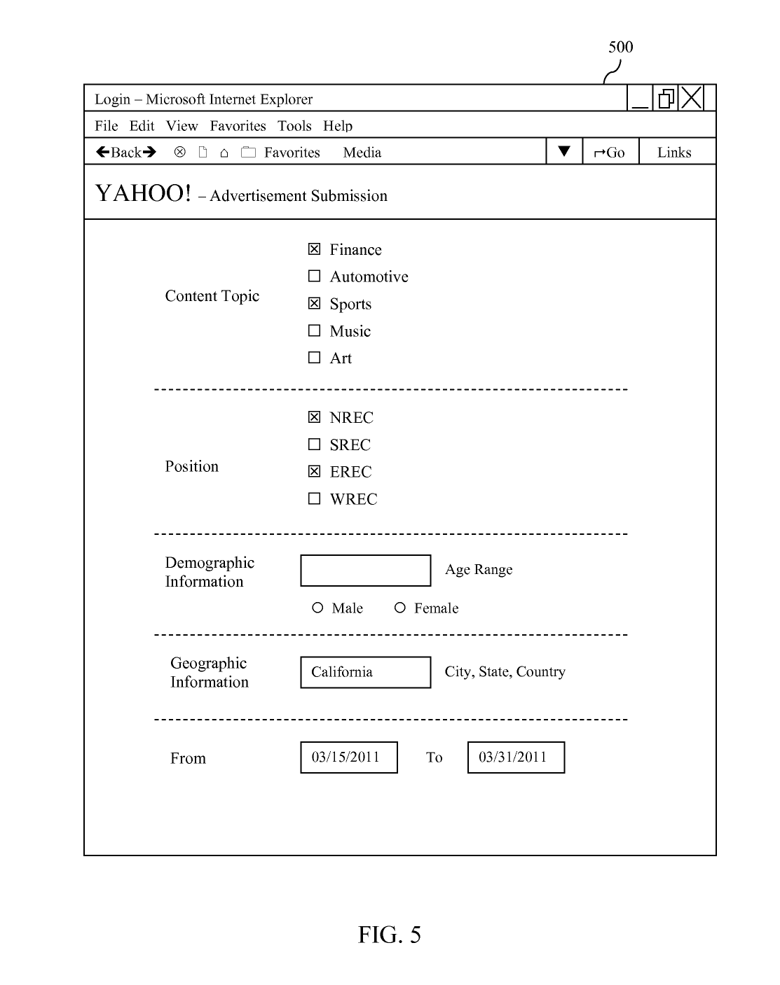

By way of example. FIG. 5 depicts an exemplary graphical user interface (GUI) 500 that may be presented to an advertiser, such as advertiser 130, by inventory management system 110. GUI 500 may be used by the advertiser to obtain availability information for certain types of advertising opportunities by selecting one or more target attributes from among a finite set of attributes and then specifying one or more target values for each of the selected target attributes. It is noted that GUI 500 is described herein by way of example only, and various other types of interfaces may be used.

As shown in FIG. 5, GUI 500 enables an advertiser to select from among the following attributes associated with advertising opportunities: content topic, position, demographic information (including age range and gender), geographic information and duration. The advertiser may select one or more of five different target values for content topic including finance, automotive, sports, music and art. The advertiser may select one or more of four different target values for position including NREC (north rectangle), SREC (south rectangle), EREC (east rectangle) and WREC (west rectangle). With respect to demographic information attributes, the advertiser may specify a number representative of an age range and may select a gender of male and/or female. With respect to geographic information attributes, the advertiser may specify a city, state and/or country. For the duration attribute, the advertiser may specify a start date and an end date.

In the example shown in FIG. 5, the advertiser has selected target values of sports and finance for the content topic attribute, has selected target values of NREC and EREC for the position attribute, has specified California for the geographic information attribute and has specified a duration of Mar. 15, 2011 to Mar. 31, 2011.

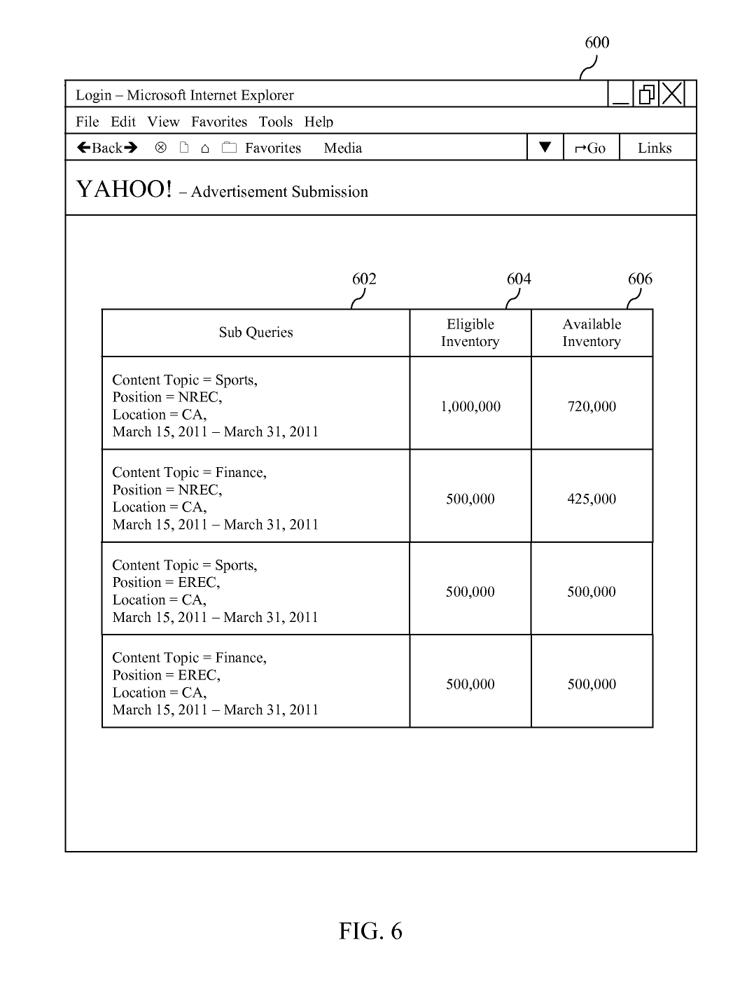

Responsive to receiving the selected target attributes and associated target values from an advertiser via an interface, admission control system 142 (or some other entity within inventory management system 110) generates a query based on the selected, target attributes and associated target values. Where multiple target values are specified for at least one target attribute, a bulk query is generated. For example, with continued reference to example GUI 500 shown in FIG. 5, the selected target attributes and associated target values may be utilized to generate the following bulk query:
Q: Content Topic=(Sports, Finance), Position=(NRFC, EREC), Location=CA; Mar. 15, 2011-Mar. 31, 2011
   It can be seen that the foregoing bulk query Q is really the union of the following constituent queries:
Q1: Content Topic=Sports, Position=NREC, Location=CA; Mar. 15, 2011-Mar. 31, 2011
Q2: Content Topic=Finance, Position=NREC, Location=CA; Mar. 15, 2011-Mar. 31, 2011
Q3: Content Topic=Sports, Position=EREC, Location=CA; Mar. 15, 2011-Mar. 31, 2011
Q4: Content Topic=Finance, Position=EREC, Location=CA; Mar. 15, 2011-Mar. 31, 2011
   Ideally, the advertiser providing the bulk query would like to see an estimate of the eligible and available advertising opportunities for each of the constituent queries. For example. FIG. 6 depicts an example GUI 600 for presenting the advertiser with results of bulk query Q. As shown in FIG. 6, GUI 600 includes a first column 602 that lists each of the constituent queries Q1-Q4 (referred to in FIG. 6 as “sub queries”) a second column 604 that lists the eligible inventory of advertising opportunities corresponding to each constituent query, and a third column 606 that lists the available inventory of advertising opportunities corresponding to each constituent query. As used herein, the term “eligible advertising opportunities” refers to the number of forecasted advertising opportunities that match a particular query, whereas “available advertising opportunities” refers to the number of eligible advertising opportunities that remain after accounting for consumption of those eligible advertising opportunities by existing advertising campaigns.

One approach to determining the eligible and available advertising opportunities for each of the constituent queries Q1-Q4 would be to separately process each of the constituent queries in accordance with the approach described in the preceding section using the same representative sampling resolution as is used for non-bulk queries. However, it is possible that a bulk query can comprise tens and even hundreds of constituent queries. In this case, processing each of the constituent queries in the manner described in the preceding section using the same representative sampling resolution as is used for non-bulk queries can either take too long if the constituent queries are processed serially or, if the constituent queries are processed in parallel, can flood inventory management system 110 (consuming too much throughput), rendering inventory management system 110 unresponsive to other queries that other advertisers might pose.

One possible approach to addressing this issue is to process the bulk query in accordance with a “fuzzy processing” technique as described in commonly-owned, co-pending U.S. patent application Ser. No. 12/970,505, filed on Dec. 16, 2010, the entirety of which is incorporated by reference herein. This approach will now be briefly described.

The “fuzzy processing” approach is essentially a two-phase approach. During the first phase, admission control system 142 obtains supply samples from supply forecasting system 144 for the bulk query that represents the forecasted supply for all the constituent queries taken together. Admission control system 142 then computes the available inventory of advertising opportunities for the supply samples by considering allocations to existing advertising campaigns as related through allocation plan 152. During the second phase, admission control system 142 determines for each supply sample, which constituent query that supply sample would belong to. Admission control system 142 then computes the available inventory of advertising opportunities for each constituent query accordingly.

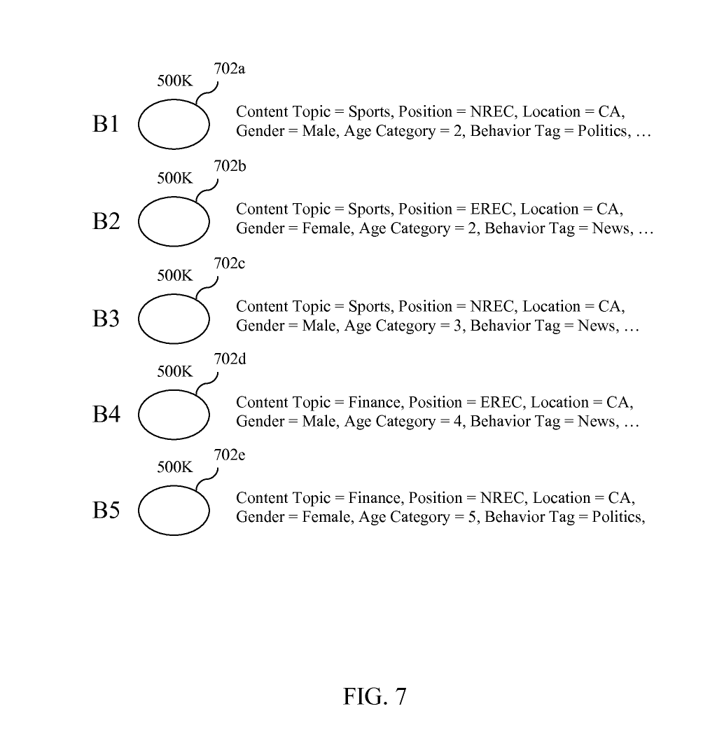

This approach will now be illustrated with continued reference to the example bulk query
Q: Content Topic=(Sports, Finance), Position=(NREC, EREC), Location=CA; Mar. 15, 2011-Mar. 31, 2011
   which is the union of constituent queries Q1-Q4 as described above. During the first phase of the process, admission control system 142 obtains supply samples from supply forecasting system 144 for the bulk query that represents the forecasted supply for all the constituent queries Q1-Q4 taken together. FIG. 7 illustrates five supply samples, B1-B5 (corresponding to reference numerals 702a-702e), that may be returned by supply forecasting system 144 in response to the submission of bulk query Q. In accordance with this example, responsive to receiving bulk query Q, supply forecasting system 144 determines a total amount of forecasted supply for the bulk query, which is 2,500,000 advertising opportunities. Supply forecasting system 144 then selects a subset of the forecasted supply for the bulk query, which in this example is five supply samples, to represent the total forecasted supply. The number of advertising opportunities represented by each supply sample B1-B5 is denoted by a weight associated with each sample in this case, each supply sample B1-B5 represents 500,000 samples and thus, supply samples B1-B5 collectively represent all 2,500,000 forecasted advertising opportunities. It is to be understood that supply samples B1-B5 shown in FIG. 7 have timestamps in the duration range of bulk query Q as discussed above (i.e., in the time range of Mar. 15, 2011-Mar. 31, 2011).

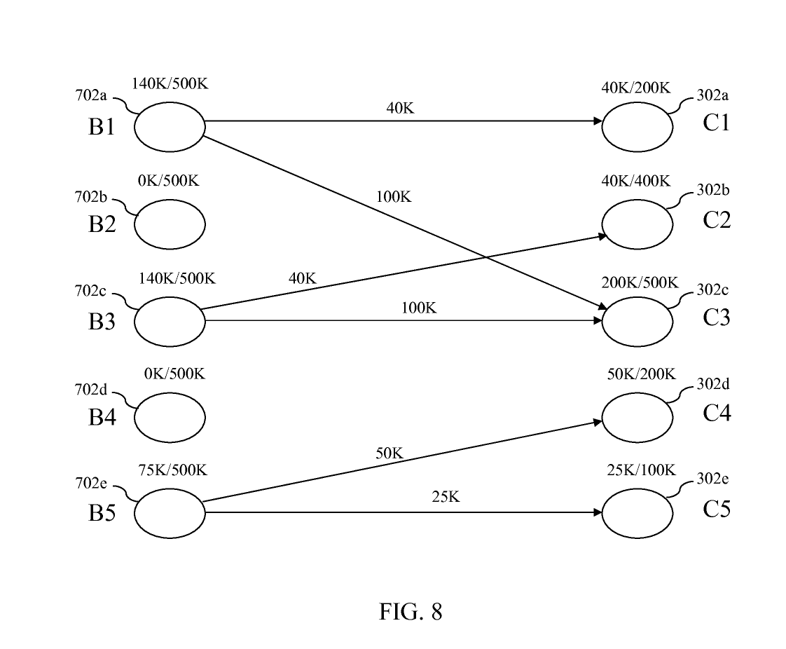

As noted above, admission control system 142 then computes the available inventory of advertising opportunities for the supply samples B1-B5 by considering allocations to existing advertising campaigns as related through allocation plan 152. For the purpose of this example, it will be assumed that the existing advertising campaigns are the five advertising campaigns, C1-C5 (corresponding to reference numerals 302a-302e), previously described in reference to FIG. 3. For example. FIG. 8 illustrates the allocation of the forecasted supply of advertising opportunities represented by supply samples B1-B5 as previously described in reference to FIG. 7 to existing advertising campaigns C1-C5 as previously described in reference to FIG. 3. It is to be assumed that each of advertising campaigns C1-C5 is active during the relevant time window of Mar. 15, 2011-Mar. 31, 2011.

As shown in FIG. 8, admission control system 142 estimates that advertising campaign C1 will consume 40,000 of the advertising opportunities represented by supply sample B1, that advertising campaign C2 will consume 40,000 of the advertising opportunities represented by supply sample B3, that advertising campaign C3 will consume 100,000 of the advertising opportunities represented by supply sample B1 and 100,000 of the advertising opportunities represented by supply sample B3, that advertising campaign C4 will consume 50,000 of the advertising opportunities represented by supply sample B5 and that advertising campaign C5 will consume 25,000 of the advertising opportunities represented by supply sample B5.

After admission control system 142 has determined the allocation of the forecasted supply of advertising opportunities represented by supply samples B1-B5 to each of the advertising campaigns C1-C5, admission control system 142 then reduces the weights associated with the supply samples B1-B5 accordingly. Thus, in further accordance with the example shown in FIG. 8, since a total of 140,000 of the advertising samples represented by supply sample B1 have been allocated to existing advertising campaigns, the weight associated with supply sample 131 is reduced to 360,000. Using a like approach, the weight associated with supply sample B3 is reduced to 360,000 and the weight associated with supply sample B5 is reduced to 425,000. The weights associated with supply samples 132 and B4 are not reduced, since none of the advertising opportunities represented by those supply samples have been allocated to existing advertising campaigns.

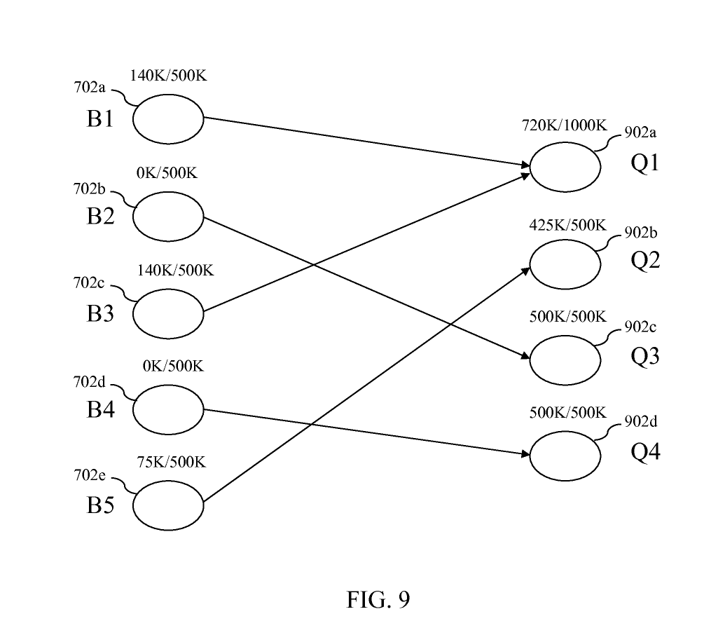

As also noted above, during the second phase of the “fuzzy processing” approach, admission control system 142 determines for each supply sample B1-B5, which constituent query Q1-Q4 that supply sample would belong to Admission control system 142 then computes the available inventory of advertising opportunities for each constituent query Q1-Q4 accordingly. This process is illustrated in FIG. 9. As shown in that figure, since the attributes/values of supply samples B1 and B3 match the target attributes/values of constituent query Q1, the adjusted weights associated with supply samples B1 and B3 (360,000 each) are allocated to constituent query Q1. Thus, constituent query Q1 is determined to have an eligible supply of 1,000,000 advertising opportunities and an available supply of 720,000 advertising opportunities. In a like manner it may be determined that constituent query Q2 has an eligible supply of 500,000 advertising opportunities and an available supply of 425,000 advertising opportunities, that constituent query Q3 has an eligible supply of 500,000 advertising opportunities and an available supply of 500,000 advertising opportunities, and that constituent query Q4 has an eligible supply of 500,000 advertising opportunities and an available supply of 500,000 advertising opportunities.

Processing a bulk query using the foregoing two-phase “fuzzy processing” approach is advantageous in that it can provide improved performance, both in terms of reduced latency and increased throughput, as compared to an approach that processes each of the constituent queries in accordance with the approach described in the preceding section using the same representative sampling resolution as is used for non-bulk queries. However, this high performance is achieved by losing accuracy in terms of representing the supply for the constituent queries. In particular, larger constituent queries dominate the smaller constituent queries within a bulk query, and the smaller constituent queries may not have enough resolution/accuracy. In the worst case, a smaller constituent query may end up with zero available advertising opportunities, even though there are in fact advertising opportunities available for that constituent query. If these unrepresented advertising opportunities are ones in which an advertiser would be interested, this can represent a lost opportunity for both the advertiser and the publisher. The following section describes further approaches to processing bulk queries that address this issue.

### E. Example Bulk Query Processing Techniques with Improved Resolution/Accuracy for Smaller Constituent Queries

In accordance with one embodiment of the present invention, bulk queries are handled by processing the constituent queries associated therewith separately, using a minimum resolution that is smaller than a resolution normally used to process non-bulk queries. By utilizing a smaller than normal resolution for processing the constituent queries, this approach reduces the burden on inventory management system 110 in terms of both throughput and latency as compared to an approach that processes the constituent queries at a resolution level normally used to process non-bulk queries. Furthermore, this approach is advantageous in that it guarantees some minimum resolution for each constituent query, such that at least some supply samples will be allocated to each constituent query.

In accordance with certain implementations, the minimum resolution comprises a configurable parameter of inventory management system 110, the value of which may be set by a system administrator or other authorized entity. Such configurable parameter may then be accessed and used whenever a bulk query is processed. A higher parameter value will result in more accurate query results but also higher latency of query processing and lower system throughput.

In certain embodiments, the parameter that specifies the minimum resolution may also be set on a per-query basis or a per-advertiser basis. For example, with respect to setting the minimum resolution parameter on a per-advertiser basis, a higher minimum resolution may be allocated to certain advertisers that are deemed “premium customers,” at the expense of consuming higher system throughput. In still further embodiments, the minimum resolution parameter may also be derived based on a current workload or performance level of inventory management system 110. For example, when the current system workload is low or performance level is high, a higher minimum resolution parameter may be used.

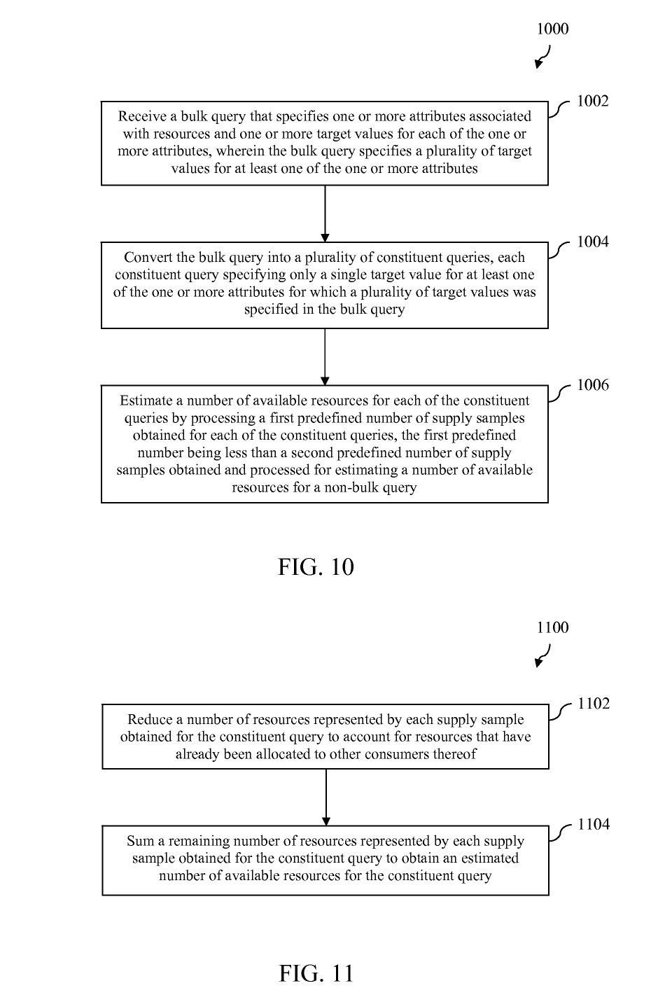

FIG. 10 depicts a flowchart 1000 of a method for determining the availability of a resource, such as an advertising opportunity, in accordance with an embodiment in which constituent queries associated with a bulk query are processed at a minimum resolution level as discussed above. The method of flowchart 1000 will be described with continued reference to inventory management system 110 as described above in reference to FIG. 1. However, it is noted that the method of flowchart 1000 may be utilized by other systems entirely and may also be used to determine the availability of other types of resources.

As shown in FIG. 10, the method of flowchart 1000 begins at step 1002 in which a bulk query is received that specifies one or more attributes associated with resources and one or more target values for each of the one or more attributes, wherein the bulk query specifies a plurality of target values for at least one of the one or more attributes. This step may be performed, for example, by admission control system 142 of inventory management system 110.

At step 1004, the bulk query is converted into a plurality of constituent queries, wherein each constituent query specifies only a single target value for at least one of the one or more attributes for which a plurality of target values was specified in the bulk query. This step may also be performed, for example, by admission control system 142 of inventory management system 110.

At step 1006, a number of available resources is estimated for each of the constituent queries by processing a first predefined number of supply samples obtained for each of the constituent queries, wherein each of the supply samples obtained for a particular constituent query represents resources that satisfy the particular constituent query. This step may be performed, for example, by admission control system 142 of inventory management system 110 operating in conjunction with supply forecasting system 144. In accordance with this method, the first predefined number of supply samples obtained for each of the constituent queries is less than a second predefined number of supply samples that is obtained and processed for estimating a number of available resources for a non-bulk query. By using a smaller number of supply samples for processing the constituent queries as compared to the number of supply samples used to process a non-bulk query, this embodiment will reduce the system burden and latency associated with processing the constituent queries as compared to non-bulk queries while still guaranteeing a minimum resolution for each constituent query, such that at least some supply samples will represent each constituent query.

FIG. 11 depicts a flowchart 1100 of a method that may be utilized to perform step 1006 of flowchart 1000. The method of flowchart 1100 is performed for each of the constituent queries associated with the bulk query received during step 1002. As shown in FIG. 11, the method of flowchart 1100 begins at step 1102, during which a number of resources represented by each supply sample obtained for the constituent query is reduced to account for resources that have already been allocated to other consumers thereof. At step 1104, a remaining number of resources represented by each supply sample obtained for the constituent query are summed to obtain an estimated number of available resources thr the constituent query.

It will be appreciated by persons skilled in the relevant art(s) that the size of the first predefined number mentioned, step 1006 will determine the resolution used to process each constituent query. As noted above, this number may comprise a parameter that is configurable by a system administrator or other authorized entity, may be determined on a per-query basis, may be determined based on an identity of an entity on whose behalf the bulk query was submitted, or may be determined based on a current system workload and/or performance level.

In accordance with a further embodiment of the present invention, bulk queries are processed in accordance with the “fuzzy processing” approach described in the preceding section, but using a maximum resolution that is higher than a resolution normally used to process non-bulk queries. By utilizing a higher resolution for processing the bulk query, the estimated available supply for each constituent query will also be determined at a higher resolution, since those estimates draw from the supply samples obtained for the bulk query. This approach is beneficial in that it limits the number of queries to be processed by inventory management system 110 to just a single query per bulk query, thus leading to higher system throughput and possibly lower latency.

In accordance with certain implementations, the maximum resolution comprises a configurable parameter of inventory management system 110, the value of which may be set by a system administrator or other authorized entity. Such configurable parameter may then be accessed and used whenever a bulk query is processed. A higher parameter value will result in more accurate query results but also higher latency of query processing and lower system throughput.

In certain embodiments, the parameter that specifies the maximum resolution may also be set on a per-query basis or a per-advertiser basis. For example, with respect to setting the maximum resolution parameter on a per-advertiser basis, a higher maximum resolution may be allocated to certain advertisers that are deemed “premium customers,” at the expense of consuming higher system throughput. In still further embodiments, the maximum resolution parameter may also be derived based on a current workload or performance level of inventory management system 110. For example, when the current system workload is low or performance level is high a higher maximum resolution parameter may be used.

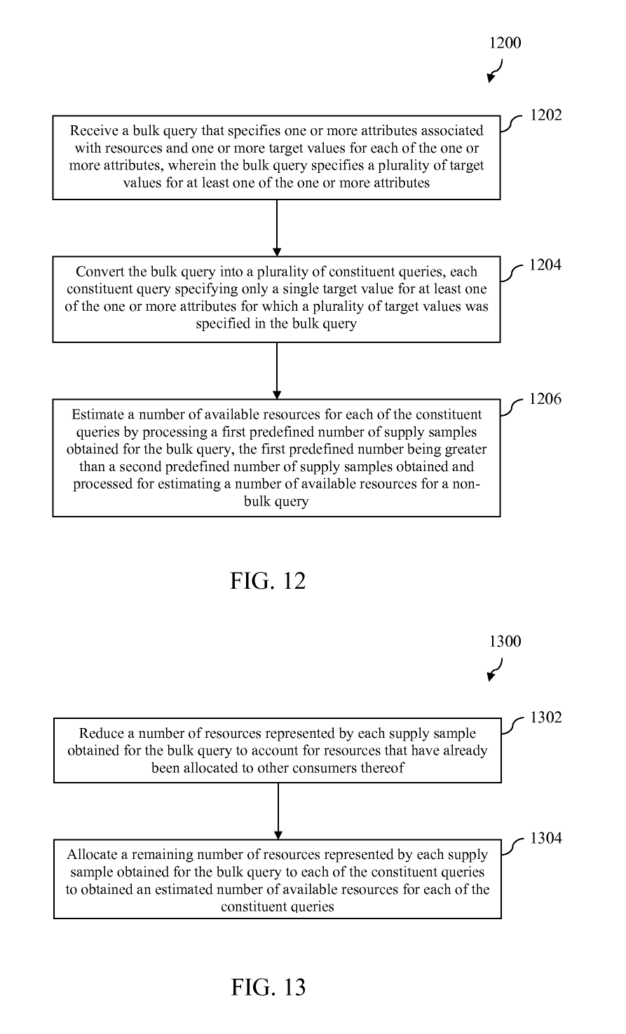

FIG. 12 depicts a flowchart 1200 of a method for determining the availability of resources, such as advertising opportunities, in accordance with an embodiment in which a bulk query is processed at a maximum resolution level as discussed above. The method of flowchart 1200 will be described with continued reference to inventory management system 110 as described above in reference to FIG. 1. However, it is noted that the method of flowchart 1200 may be utilized by other systems entirely and may also be used to determine the availability of other types of resources.

As shown in FIG. 12, the method of flowchart 1200 begins at step 1202 in which a hulk query is received that specifies one or more attributes associated with resources and one or more target values for each of the one or more attributes, wherein the bulk query specifies a plurality of target values for at least one of the one or more attributes. This step may be performed, for example, by admission control system 142 of inventory management system 110.

At step 1204, the bulk query is converted into a plurality of constituent queries, wherein each constituent query specifies only a single target value for at least one of the one or more attributes for which a plurality of target values was specified in the bulk query. This step may also be performed, for example, by admission control system 142 of inventory management system 110.

As step 1206, a number of available resources is estimated for each of the constituent queries by processing a first predefined number of supply samples obtained for the bulk query, wherein the supply samples obtained for the bulk query represent resources that satisfy the bulk query. This step may be performed, for example, by admission control system 142 of inventory management system 110 operating in conjunction with supply forecasting system 144. In accordance with this method, the first predefined number of supply samples obtained for the bulk query is greater than a second predefined number of supply samples that is obtained and processed for estimating a number of available resources for a non-bulk query. By using a larger number of supply samples for processing the bulk query as compared to the number of supply samples used to process a non-bulk query, this embodiment will obtain an estimated available supply for each constituent query at a higher resolution, since those estimates draw from the supply samples obtained for the bulk query. Furthermore, by processing only a single bulk query rather than all the constituent queries associated therewith, this embodiment can achieve higher system throughput and possibly lower latency.

FIG. 13 depicts a flowchart 1300 of a method that may be utilized to perform step 1206 of flowchart 1200. As shown in FIG. 13, the method of flowchart 1300 begins at step 1302, during which a number of resources represented by each supply sample obtained for the bulk query is reduced to account for resources that have already been allocated to other consumers thereof. At step 1304, a remaining number of resources represented by each supply sample obtained for the bulk query is allocated to each of the constituent queries to obtain an estimated number of available resources for each of the constituent queries.

It will be appreciated by persons skilled in the relevant art(s) that the size of the first predefined number mentioned step 1206 will determine the resolution used to process the bulk query. As noted above, this number may comprise a parameter that is configurable by a system administrator or other authorized entity, may be determined on a per-query basis, may be determined based on an identity of an entity on whose behalf the bulk query was submitted, or may be determined based on a current system workload and/or performance level.

In accordance with a still further embodiment of the present invention, bulk queries are processed in accordance with the approach represented by flowchart 1000 of FIG. 10 if the number of constituent queries does not exceed a predefined threshold and are processed in accordance with the approach represented by flowchart 1200 of FIG. 12 if the number of constituent queries does exceed the predefined threshold. In accordance with such an embodiment, the predefined threshold may be set to a desired level so as to avoid separately processing constituent queries when the number of such queries is deemed to be too large, thus impacting system throughput and latency in an unacceptable manner. Like the minimum and maximum resolution parameters discussed above, the predefined threshold may be exposed as a configurable system parameter accessible to a system administrator or other authorized entity.

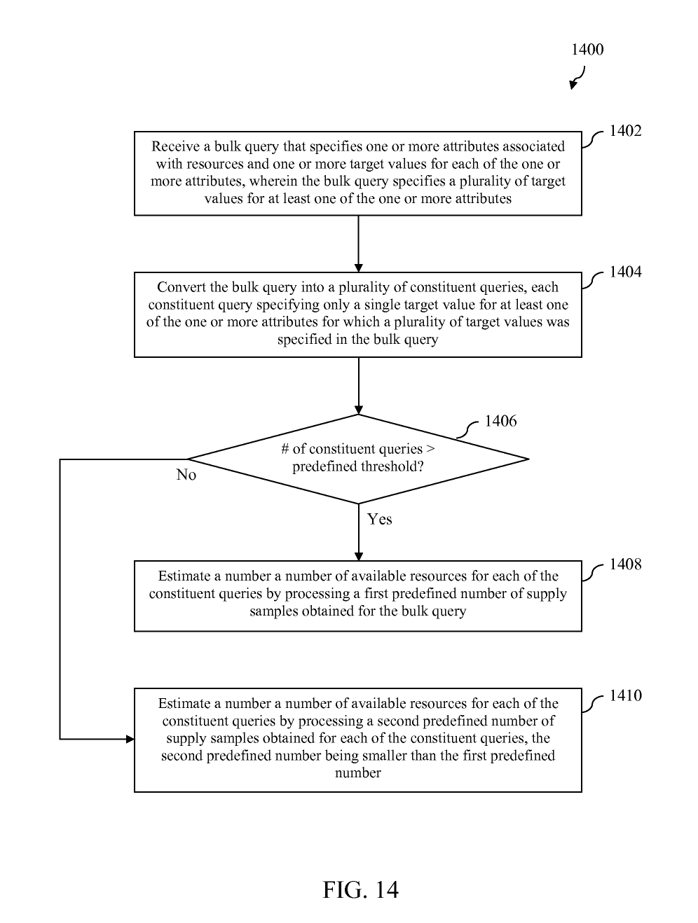

FIG. 14 depicts a flowchart 1400 of a method in accordance with such an embodiment. The method of flowchart 1400 will be described with continued reference to inventory management system 110 as described above in reference to FIG. 1. However, it is noted that the method of flowchart 1400 may be utilized by other systems entirely and may also be used to determine the availability of other types of resources.

As shown in FIG. 14, the method of flowchart 1400 begins at step 1402 in which a bulk query is received that specifies one or more attributes associated with resources and one or more target values for each of the one or more attributes, wherein the bulk query specifies a plurality of target values for at least one of the one or more attributes. This step may be performed, for example, by admission control system 142 of inventory management system 110.

At step 1404, the bulk query is converted into a plurality of constituent queries, wherein each constituent query specifies only a single target value for at least one of the one or more attributes for which a plurality of target values was specified in the bulk query. This step may also be performed, for example, by admission control system 142 of inventory management system 110.

At decision step 1406, it is determined whether the number of constituent queries in the plurality of constituent queries exceeds a predefined threshold. This step may also be performed, for example, by admission control system 142 of inventory management system 110.

If it is determined at decision step 1406 that the number of constituent queries in the plurality of constituent queries exceeds the predefined threshold, then control flows to step 1408. During step 1408, a number of available resources is estimated for each of the constituent queries by processing a first predefined number of supply samples obtained for the bulk query, the supply samples obtained for the bulk query representing resources that satisfy the bulk query. The processing of the supply samples may be carried, out in accordance with the method of flowchart 1300 for example. This step may be performed, for example, by admission control system 142 of inventory management system 110 operating in conjunction with supply forecasting system 144.

However, if it is determined at decision step 1406 that the number of constituent queries in the plurality of constituent queries does not exceed the predefined threshold, then control flows to step 1410. During step 1110, a number of available resources is estimated for each of the constituent queries by processing a second predefined number of supply samples obtained for each of the constituent queries, each of the supply samples obtained for a particular constituent query representing resources that satisfy the particular constituent query. The processing of the supply samples may be carried out in accordance with the method of flowchart 1100 for example. This step may be performed, for example, by admission control system 112 of inventory management system 110 operating in conjunction with supply forecasting system 144.

### F. Example Computer System Implementation

Inventory management system 110, advertisement serving system 120, and any of the sub-systems or components contained therein may be implemented in hardware, software, firmware, or any combination thereof. For example, inventory management system 110, advertisement serving system 120, and any of the sub-systems or components contained therein may be implemented as computer program code configured to be executed in one or more processors. Alternatively, inventory management system 110, advertisement serving system 120, and any of the sub-systems or components contained therein may be implemented as hardware logic/electrical circuitry.

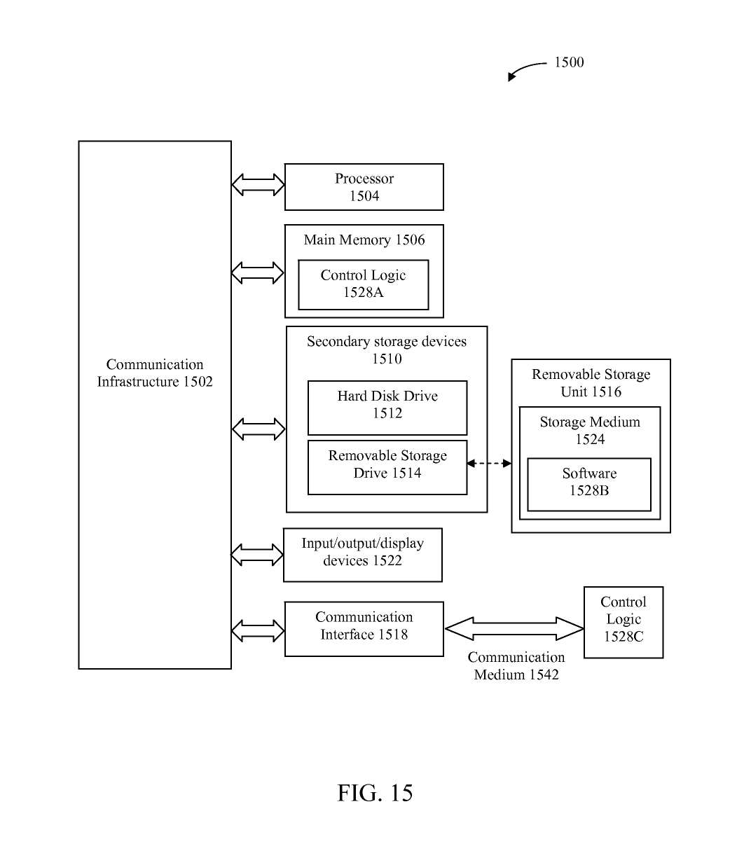

The embodiments described herein, including systems, methods/processes, and/or apparatuses, may be implemented using well known servers/computers, such as a computer 1500 shown in FIG. 15. For example, inventory management system 110, advertisement serving system 120, and any of the sub-systems or components contained therein may be implemented using one or more computers 1500.

Computer 1500 can be any commercially available and well known computer capable of performing the functions described herein, such as computers available from International Business Machines, Apple, Sun, HP, Deli, Cray, etc. Computer 1500 may be any type of computer, including a desktop computer, a server, etc.

Computer 1500 includes one or more processors (also called central processing units, or CPUs), such as a processor 1504. Processor 1504 is connected to a communication infrastructure 1502, such as a communication bus. In some embodiments, processor 1504 can simultaneously operate multiple computing threads.

Computer 1500 also includes a primary or main memory 1506, such as random access memory (RAM). Main memory 1506 has stored therein control logic 1528A (computer software), and data.

Computer 1500 also includes one or more secondary storage devices 1510. Secondary storage devices 1510 include, for example, a hard disk drive 1512 and/or a removable storage device or drive 1514, as well as other types of storage devices, such as memory cards and memory sticks. For instance, computer 1500 may include an industry standard interface, such a universal serial bus (USB) interface for interfacing with devices such as a memory stick. Removable storage drive 1514 represents a floppy disk drive, a magnetic tape drive, a compact disk drive, an optical storage device, tape backup, etc.

Removable storage drive 1514 interacts with a removable storage unit 1516. Removable storage unit 1516 includes a computer useable or readable storage medium 1524 having stored therein computer software 1528B (control logic) and/or data. Removable storage unit 1516 represents a floppy disk, magnetic tape, compact disk, DVD, optical storage disk, or any other computer data storage device. Removable storage drive 1514 reads from and/or writes to removable storage unit 1516 in a well known manner.

Computer 1500 also includes input/output/display devices 1522, such as monitors, keyboards, pointing devices, etc.

Computer 1500 further includes a communication or network interface 1518. Communication interface 1518 enables computer 1500 to communicate with remote devices. For example, communication interface 1518 allows computer 1500 to communicate over communication networks or mediums 1542 (representing a form of a computer useable or readable medium), such as LANs, WANs, the Internet, etc. Network interface 1518 may interface with remote sites or networks via wired or wireless connections.

Control logic 1528C may be transmitted to and from computer 1500 via the communication medium 1542.

Any apparatus or manufacture comprising a computer useable or readable medium having control logic (software) stored therein is referred to herein as a computer program product or program storage device. This includes, but is not limited to, computer 1500, main memory 1506, secondary storage devices 1510, and removable storage unit 1516. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable media. Examples of such computer-readable storage media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may store program modules that include computer program logic for implementing the features of inventory management system 110, advertisement serving system 120, and any of the sub-systems or components contained therein, any of the methods or steps of the flowcharts of FIGS. 10-14, and/or further embodiments of the present invention described herein. Embodiments of the invention are directed to computer program products comprising such logic (e.g., in the form of program code or software) stored on any computer useable medium. Such program code, when executed in one or more processors, causes a device to operate as described herein.

The invention can work with software, hardware, and/or operating system implementations other than those described herein. Any software, hardware, and operating system implementations suitable for performing the functions described herein can be used.

### G. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for automatically determining the availability of resources, comprising:
receiving a bulk query that specifies one or more attributes associated with the resources and one or more target values for each of the one or more attributes, wherein the bulk query specifies a plurality of target values for at least one of the one or more attributes;
converting the bulk query into a plurality of constituent queries, wherein each constituent query specifies only a single target value for at least one of the one or more attributes for which a plurality of target values was specified in the bulk query;
estimating a number of available resources for each of the constituent queries by processing a first predefined number of supply samples obtained for each of the constituent queries, each of the supply samples obtained for a particular constituent query representing resources that satisfy the particular constituent query;
wherein the first predefined number of supply samples obtained for each of the constituent queries is less than a second predefined number of supply samples obtained and processed for estimating a number of available resources for a non-bulk query.

2. The method of claim 1, wherein the resources comprise display advertisement opportunities.

3. The method of claim 1, wherein processing the first predefined number of supply samples obtained for each of the constituent queries comprises:
for each of the constituent queries:
reducing a number of resources represented by each supply sample obtained for the constituent query to account for resources that have already been allocated to other consumers thereof, and
summing a remaining number of resources represented by each supply sample obtained for the constituent query to obtain an estimated number of available resources for the constituent query.

4. The method of claim 1, wherein the first predefined number comprises a parameter that is configurable by a system administrator.

5. The method of claim 1, wherein the first predefined number is determined on a per-query basis.

6. The method of claim 1, wherein the first predefined number is determined based on an identity of an entity on whose behalf the bulk query was submitted.

7. The method of claim 1, wherein the first predefined number is determined based on a current system workload and/or performance level.

8. A method for automatically determining the availability of resources, comprising:
receiving a bulk query that specifies one or more attributes associated with the resources and one or more target values for each of the one or more attributes, wherein the bulk query specifies a plurality of target values for at least one of the one or more attributes;
converting the bulk query into a plurality of constituent queries, wherein each constituent query specifies only a single target value for at least one of the one or more attributes for which a plurality of target values was specified in the bulk query;
estimating a number of available resources for each of the constituent queries by processing a first predefined number of supply samples obtained for the bulk query, the supply samples obtained for the bulk query representing resources that satisfy the bulk query;
wherein the first predefined number of supply samples obtained for the hulk query is greater than a second predefined number of supply samples obtained and processed for estimating a number of available resources for a non-bulk query.

9. The method of claim 8, wherein the resources comprise display advertisement opportunities.

10. The method of claim 8, wherein processing the first predefined number of supply samples obtained for the bulk query comprises:
reducing a number of resources represented by each supply sample obtained for the bulk query to account for resources that have already been allocated, to other consumers thereof; and
allocating a remaining number of resources represented by each supply sample obtained for the bulk query to each of the constituent queries to obtain an estimated number of available resources for each of the constituent queries.

11. The method of claim 8, wherein the first predefined number comprises a parameter that is configurable by a system administrator.

12. The method of claim 8, wherein the first predefined number is determined on a per-query basis.

13. The method of claim 8, wherein the first predefined number is determined based on an identity of an entity on whose behalf the bulk query was submitted.

14. The method of claim 8, wherein the first predefined number is determined based on a current system workload and/or performance level.

15. A method for automatically determining the availability of resources, comprising:
receiving a bulk query that specifies one or more attributes associated with the resources and one or more target values for each of the one or more attributes, wherein the bulk query specifies a plurality of target values for at least one of the one or more attributes;
converting the bulk query into a plurality of constituent queries, wherein each constituent query specifies only a single target value for at least one of the one or more attributes for which a plurality of target values was specified in the bulk query;
responsive to determining that the number of constituent queries in the plurality of constituent queries exceeds a predefined threshold, estimating a number of available resources for each of the constituent queries by processing a first predefined number of supply samples obtained, for the bulk query, the supply samples obtained for the bulk query representing resources that satisfy the bulk query; and
responsive to determining that the number of constituent queries in the plurality of constituent queries does not exceed the predefined threshold, estimating a number of available resources for each of the constituent queries by processing a second predefined number of supply samples obtained for each of the constituent queries, each of the supply samples obtained for a particular constituent query representing resources that satisfy the particular constituent query;
wherein the first predefined number is larger than the second predefined number.

16. The method of claim 15, wherein the resources comprise display advertisement opportunities.

17. The method of claim 15, wherein processing the first predefined number of supply samples obtained for the bulk query comprises:
reducing a number of resources represented by each supply sample obtained for the bulk query to account for resources that have already been allocated to other consumers thereof; and
allocating a remaining number of resources represented by each supply sample obtained for the bulk query to each of the constituent queries to obtain an estimated number of available resources for each of the constituent queries.

18. The method of claim 15, wherein processing the second predefined number of supply samples obtained for each of the constituent queries comprises:
for each of the constituent queries:
reducing a number of resources represented by each supply sample obtained for the constituent query to account for resources that have already been allocated to other consumers thereof, and
summing a remaining number of resources represented by each supply sample obtained for the constituent query to obtain an estimated number of available resources for the constituent query.

19. The method of claim 15, wherein at least one of the first predefined number, the second predefined number and the predefined threshold comprises a parameter that is configurable by a system administrator.

20. The method of claim 15, wherein at least one of the first predefined number, the second predefined number and the predefined threshold is determined based on a current system workload and/or performance level.
